(19) United States
(12) Patent Application Publication
(10) Pub. No.: US 2015/0193699 A1
(43) Pub. Date: Jul. 9, 2015

(54) DATA-ADAPTIVE INSIGHT AND ACTION PLATFORM FOR HIGHER EDUCATION

(71) Applicant: CIVITAS LEARNING, INC., Austin, TX (US)

(72) Inventors: David Kil, Austin, TX (US); Jorgen Harmse, Austin, TX (US); Michael Jauch, Austin, TX (US); Kristen Hunter, Austin, TX (US); David Patschke, Round Rock, TX (US); Stephen D. Hilderbrand, Austin, TX (US); Laura Malcolm, Austin, TX (US); Darren Rhea, Austin, TX (US)

(73) Assignee: CIVITAS LEARNING, INC., Austin, TX (US)

(21) Appl. No.: 14/592,821

(22) Filed: Jan. 8, 2015

Related U.S. Application Data
(60) Provisional application No. 61/925,186, filed on Jan. 8, 2014.

(51) Int. Cl. G06N 99/00; G06F 17/30

(52) U.S. Cl. CPC G06N 99/005; G06F 17/30705

(57) ABSTRACT

An automation analytics system and method for building analytical models for an education application uses data-availability segments of students, which are clustered into segment clusters, to create the analytical models for the segment clusters using a machine learning process. The analytical models can be used to identify at least at least actionable insights.

### CROSS REFERENCE TO RELATED APPLICATION

This application is entitled to the benefit of U.S. Provisional Patent Application Ser. No. 61/925,186, filed on Jan. 8, 2014, which is incorporated herein by reference.

### BACKGROUND OF THE INVENTION

Big data mining has been a big buzzword in numerous industries, including higher education. Most data mining projects entail building predictive models to stratify population, e.g., students, based on risk scores. As an example, U.S. Patent Application Publication No. 2010/0009331 A1 by Yaskin et al. describes a method for improving student retention rates by identifying students at risk and permitting students to raise flags if they think they are at risk. As another example, Purdue's Course Signals, as described in “PURDUE SIGNALS Mining Real-Time Academic Data to Enhance Student Success” by Pistilli and Arnold, uses a set of business rules to identify students at risk. As another example, Canadian Patent Application Serial No. CA2782841 by Essa, Hanan, and Ayad describes performance prediction systems based on user-engagement activities, social connectedness, attendance activities, participation, task completion, and preparedness.

By focusing on prediction accuracies and subsequent risk-based stratification, the current approaches do not tie in insight-driven actions, thereby failing to provide a linkage between insights and outcomes from actions taken. Instead, they treat insights and action outcomes as two distinctly separate processes, resulting in ad hoc, suboptimal, tribal solutions that are difficult to implement globally across an institution. Furthermore, since features are optimized for predictive accuracy, they often fail to provide meaningful insights in guiding interventions for maximum return on investment (ROI).

Another complicating factor is the varying degree of data availability for students. For example, incoming freshmen have very little data for most institutions while some may have their American College Test (ACT), SAT, and application data stored in student information system (SIS). A similar situation applies to transfer students, where most institutions may have only their transfer credits and possibly grade point average (GPA) without getting down to enrollment-level grades. This variety of data availability hampers the ability to develop high-accuracy models with great insights as insightful features may apply to a small subset of the student population, which prevents them from winning the combinatorial feature ranking war.

As an example, U.S. Pat. No. 8,392,153 by Pednault and Natarajan describes segmentation-based predictive models, but they rely on a decision-tree approach by segmenting valid data into an appropriate number of segments for model building tailored to each segment. As another example, U.S. Pat. No. 8,484,085 by Wennberg discusses a patient-profile segmentation based on a range of susceptibility to different surgery risk events so that models can be optimized for each risk event.

However, none of these approaches addresses the fundamental problem of some segments of the population having only a limited subset of data. Furthermore, there can exist a variety of data-availability combinations since some students take ACT or SAT, some students have transfer credits, some students take a leave of absence and return later, etc.

What's needed is an automatic way to combine population segmentation based on data or feature availability with clustering to find natural clusters within each population segment in order to maximize both predictive accuracy and extraction of insights that can lead to interventions with high likelihood for positive outcomes.

### SUMMARY OF THE INVENTION

An automation analytics system and method for building analytical models for an education application uses data-availability segments of students, which are clustered into segment clusters, to create the analytical models for the segment clusters using a machine learning process. The analytical models can be used to identify at least actionable insights.

A method for building analytical models for an education application in accordance with an embodiment of the invention comprises extracting features from data of students, segmenting the students into data-availability segments, for each data-availability segment, determining a subset of features based on model performance, clustering the students within each data-availability segment into segment clusters using one or more features in the subset of features, for each segment cluster, determining another subset of features based on model performance, and creating the analytical models for the segment clusters using a machine learning process, the analytical models providing at least actionable insights. In some embodiments, the steps of this method are performed when program instructions contained in a computer-readable storage medium are executed by one or more processors.

An automation analytics system in accordance with an embodiment of the invention comprises a feature extraction module configured to extract features from data of students, a segmentation module configured to segment the students into data-availability segments, a segment feature optimizing module configured to determine a subset of features based on model performance for each data-availability segment, a clustering module configured to cluster the students within each data-availability segment into segment clusters using one or more features in the subset of features, a cluster feature optimizing module configured to determine another subset of features based on model performance for each segment cluster, and a model building module configured to create analytical models for the segment clusters using a machine learning process, the analytical models providing at least actionable insights.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of an automation analytics system in accordance with an embodiment of the invention.

FIG. 2 shows data-availability heat maps for three institutions in accordance with an embodiment of the invention.

FIG. 3 shows a conceptual diagram of a segment feature optimization process performed by a segment feature optimizing module of the automation analytics system in accordance with an embodiment of the invention.

FIG. 4 shows a table that contrasts differences between different clusters within a particular segment cluster in accordance with an embodiment of the invention.

FIG. 5 illustrates the approach of the automation analytics system to outcomes analysis using, for example, scholarship programs, in accordance with an embodiment of the invention.

FIG. 6 shows examples of student activity heat maps over two terms for grades A, C, and F students in accordance with an embodiment of the invention.

FIG. 7 shows examples of features used in faculty engagement/influence score construction in accordance with an embodiment of the invention.

FIG. 8 shows two class-conditional PDF plots for continuing and non-continuing students based on cumulative GPA, the number of terms completed, and affordability gap in accordance with an embodiment of the invention.

FIG. 9 shows a 4-quadrant view of students who have high-school GPA and cumulative institutional GPA in accordance with an embodiment of the invention.

FIG. 10 is a flow diagram of a method for building analytical models for an education application in accordance with an embodiment of the invention.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Embodiments of the invention relates to an automated and modular framework or system for extracting insights and building models for higher-education institutions, leveraging their Student Information System (SIS), Learning Management System (LMS), and ancillary data sources. The automation analytics system in accordance with embodiments of the invention comprises (1) complex time-series event processing, (2) feature extraction to infer cognitive and non-cognitive factors, (3) computationally efficient segmentation of static and dynamic features based on data and feature availability, (4) global feature optimization for each segment, (5) clustering of each segment, (6) separate feature optimization and predictive-model building for each cluster, and (7) marriage of predictive and propensity-score models for outcomes-driven insights. Furthermore, this automation analytics system facilitates course-specific and event-based course grade, sentiment, behavioral, and social network analyses to help identify toxic/synergistic course combinations, optimize course scheduling, and determine emerging influencers, all designed to help students succeed. Thus, the automation analytics system facilitates higher-education insight and action analyses. The automation analytics system provides a pathway between insights derived from processing institutional data and actions that take advantage of the insights to produce positive outcomes. The automation analytics system uses both impact prediction and post-action impact measurements using propensity scores for self-learning. Embodiments of this invention allow institutions to extract value from insights derived from predictive analytics.

The automation analytics system integrates both insights and insight-driven actions, i.e., interventions to improve student outcomes, using features and other information extracted from education-related data for students. These features are built to maximize both prediction accuracy and insights through time-series event processing and by differentiating performance-focused features from those that offer insights on population segments for intervention opportunities. The automation analytics system includes prediction and outcomes analytics while providing provisions for the exploration of insightful (not necessarily important for prediction accuracy) features.

These derived features from time-series event processing are computed in a modular fashion to accommodate different stages of data readiness for different clients that may utilize the automation analytics system. The client's SIS and LMS data assets can be projected onto a number of representations through ETL (Extract, Transform, and Load) and signal processing to facilitate rapid analyses of a variety of orthogonal views of student records and activities over time. From multi-year historical data, the automation analytics system can extract thousands of features and an institution-specific number of dependent variables that the automation analytics system attempts to predict. In certain cases, the automation analytics system may use external data to understand which external factors influence student success. Once the factors are identified, these factors can be embedded into a student's academic journey through an application questionnaire and/or smartphone applications to capture such factors in real time with real-time feedback.

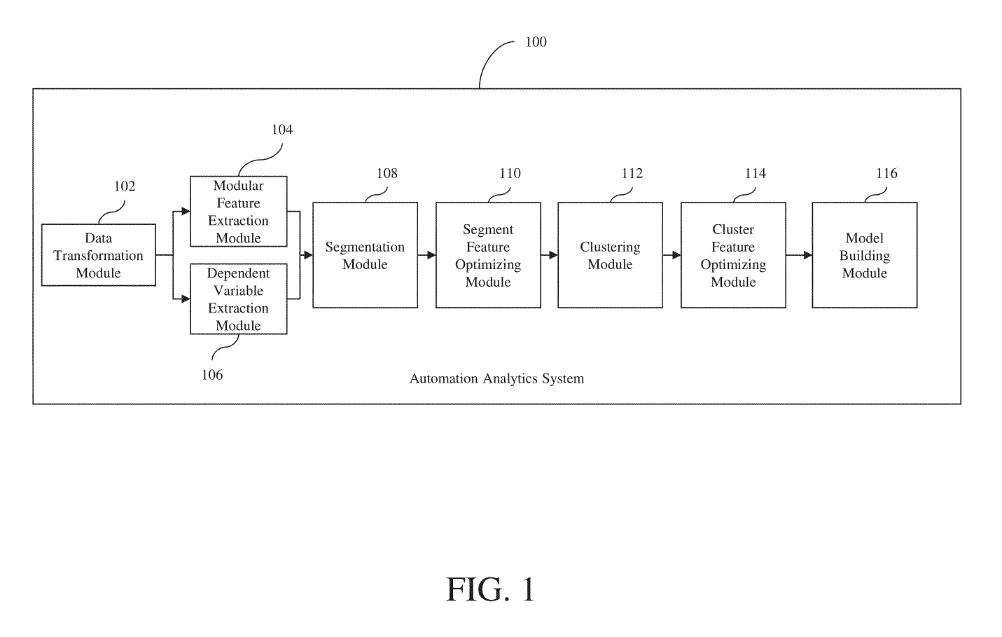

Turning now to FIG. 1, an automation analytics system 100 in accordance with an embodiment of the invention is shown. As illustrated in FIG. 1, the analytics system includes a data transformation module 102, a modular feature extraction module 104, a dependent variable extraction module 106, a segmentation module 108, a segment feature optimizing module 110, a clustering module 112, a cluster feature optimizing module 114 and a model building module 116. These components of the automation analytics system can be implemented as software, hardware or a combination of software and hardware. In some embodiments, at least some of these components of the automation analytics system are implemented as one or more software programs running in one or more computer systems using one or more processors associated with the computer systems. These components may be reside in a single computer system or distributed among multiple computer systems, which may support cloud computing.

The data transformation module 102 is configured to transform student data into usable format. The data transformation module uses data from SIS, learning management system (LMS), Customer Relationship Management (CRM), and other data sources. In particular, raw student records are transformed to enrollment, session (multiple overlapping sessions in a term), and term (for example, semester or quarter) levels for extracting features at several levels of abstraction. At the same time, raw transactional records are transformed to orthogonal views, consisting of, but not limited to, student-faculty activity-intervention-performance (AIP) maps and student-faculty/student-student interactions, such as, but not limited to, discussion boards or Facebook applications designed for on-ground courses, for natural language processing and social network, and course-combination matrices.

The modular feature extraction module 104 is configured to extract modular features from each transformation space, followed by more derived features that require multiple information from the earlier modular features. Examples of extracted features include, but not limited to, GPA standard deviation over terms, fraction of credits earned, and credit accumulation pattern. Examples of derived features include, but not limited to, affordability gap, cramming index, social network features, and Learning Management System time series trend and change features.

The dependent variable extraction module 106 is configured to extract various dependent variables from the same data set so that multiple predictive models can be built simultaneously. Examples of dependent variables encompass, but not limited to, lead-to-application conversion, incoming student success, persistence, course grade, successful course completion, graduation, student engagement, student satisfaction, and career performance.

The segmentation module 108 is configured to divide the students into segments based on feature availability and/or user definitions. Since students have different records based on how long they have been with the institution (SIS) and time since session start (LMS), data-availability segmentation is performed to group students based on what features are valid. For each student-term-offset, there may be a row of 1's and 0's based on feature validity. Typically, there may be, but not limited to, a binary matrix representation B of Eₙ₌₁^{N}^{_{students}}Γ(n)×N_{features}, where Γ(n) is the number of valid term-offsets or time snapshots of the nth student.

In order to find a unique set of data-availability combinations, B could be multiplied by a random vector r of N_{features}×1 and group the output (B*r) by unique numbers in B*r. Each unique number represents a set of student-terms or -time snapshots that have the same valid-feature combination. Depending on the number of features, fast feature ranking based on entropy measures or Fisher's discriminant ratio can be used to prune the feature set.

The first pass described above looks for 100% similarity in valid-feature combination. For modeling and insight purposes, the requirement can be relaxed by performing secondary similarity-based clustering on the unique valid-feature combination set with a similarity threshold <1. This step ensures that there is a manageable number of data-availability segments for next-level processing.

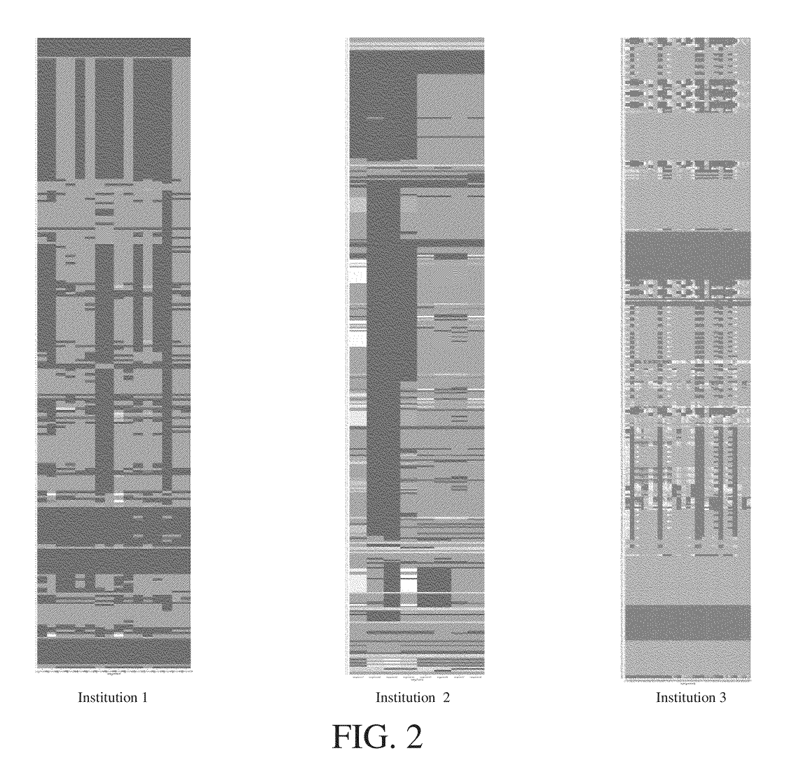

The segmentation module 108 is also configured to divide the entire feature matrix data into separate training and test data sets for training and out-of-set testing for model performance validation. In general, time-dependent partitioning may be used to stay on the conservative side. FIG. 2 shows the data-availability heat maps for three institutions, where lighter regions equal 100% available and dark regions equal 0% available. Each row represents a feature while each column represents a data-availability segment. The columns with a lot of lighter region features belong to new students who lack data footprint. The striation pattern on the heat map of the institution 3 belongs to students who skip terms.

The segment feature optimizing module 110 is configured to perform, for each data-availability segment, feature optimization and ranking using various methods including, but not limited to, combinatorial feature analysis, such as add-on, stepwise regression, and Viterbi. Performance rank-order curves can be plotted as a function of feature dimension to identify the point of diminishing returns, which prevents overfitting. Thus, the segment feature optimizing module operates to select a number of features to define an optimal feature subset for each data-availability segment. The optimal feature subset for each data-availability segment is denoted as Ω(i), where i is the data-availability segment index. The same methods can be applied if the data are segmented manually or not at all.

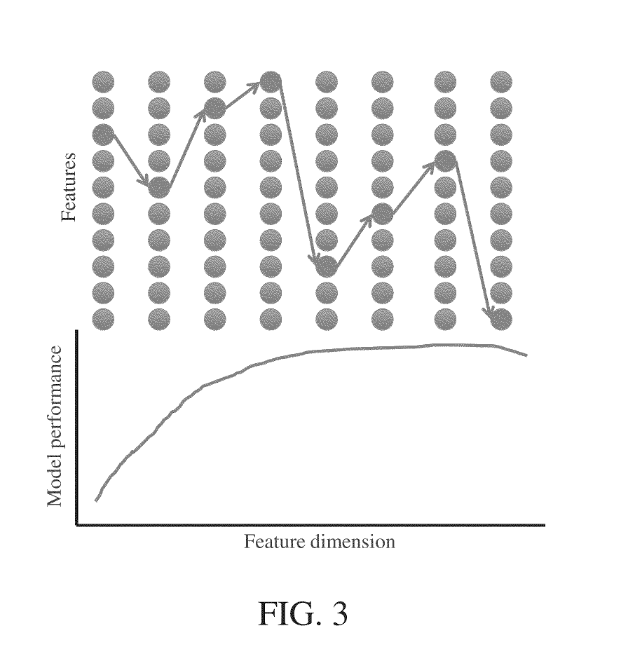

FIG. 3 shows a conceptual diagram of the segment feature optimization process performed by the segment feature optimizing module 110. Best features are added to the optimal feature subset until model performance decreases.

The clustering module 112 is configured to group the students in each of the segments into segment-clusters. Using one or more of the top features in Ω(i), the clustering module performs clustering using various methods, such as, but not limited to, k-means, expectation-maximization, and self-organizing Kohonen map. After clustering, small clusters with membership sizes below a preset threshold can be merged to increase within-cluster similarity. This two-step process ensures that each final cluster has enough samples for model robustness and insights.

Similar to the segment feature optimizing module 110, the cluster feature optimizing module 114 is configured to perform, for each segment-cluster, feature optimization and ranking using various methods. Thus, for each data-availability (DA) segment-cluster, the process of feature optimization and ranking is repeated so that each segment-cluster model has its own set of optimized features for model accuracy, robustness, and insights. This framework facilitates outcomes-based or prediction-driven clustering with combinatorial feature optimization to ensure that the clustering vector space is populated with orthogonal, insightful features.

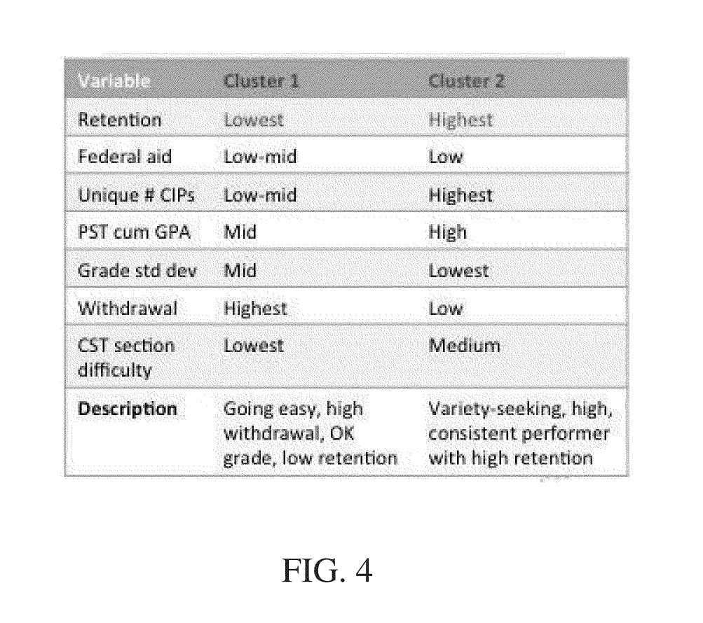

FIG. 4 illustrates an example of segment clusters based on real data. In this example, there are 5 clusters for a particular data-availability segment with common data footprint. The table shown in FIG. 4 contrasts differences between clusters 1 and 2, which are the worst and best performing clusters or cohorts, respectively, based on retention outcome. By poring through key features used in clustering, intuitive descriptions to the two student cohorts can be provided. Based on traditional grade measures, cluster 1 with mid-level GPA is not expected to exhibit the lowest retention rate. However, by combining other key variables, such as the number of unique classification of instructional program (CIP) codes (variety seeking vs. focusing on certain topics), section difficulty measures (taking mostly easy courses), grade standard deviation (measure of consistency), and course withdrawal, these findings based on real data and predictions make more sense.

The model building module 116 is configured create analytical models to extract insights and effective interventions for students at risk. The model-building module computes meta-features, such as good-feature distributions and their moments, on top features to characterize good-feature distributions in terms of normality, modality (unimodal vs. multimodal), and boundary complexity. In addition, learning algorithms are assigned based on a meta-learning algorithm that maps relationships between meta-feature characteristics and appropriate learning algorithms. For example, if class-conditional good feature distributions are unimodal and Gaussian, a simple multivariate Gaussian algorithm will suffice. However, if the distributions are highly nonlinear or multi-modal, the model building module uses nonparametric learning algorithms with an objective function that rewards accuracy and punishes model complexity. This is done to ensure that resulting models are robust with high accuracy in the presence of some data mismatches over time. Furthermore, since segments and clusters are involved, the model building module keeps track of membership distances to look for significant departures from historical data characteristics by using membership Mahalanobis distance. Any significant departure will serve as a signal to retrain models to reflect changes in data caused possibly by policy changes, new interventions, changing student mix, etc.

In order to provide predictive and intervention insights, the model building module 116 explores one-dimensional (1D), two-dimensional (2D), and three-dimensional (3D) feature density and scatter plots, and identifies through alternating binary partitioning (similar to progressive wavelet decomposition in image compression) regions where actual and predicted outcomes distributions are substantially different. Such discrepancies provide hints on how to improve models further.

In the 1D space, the model building module 116 looks for features that show separation in class-conditional probability density functions (PDFs) in any sub-regions. In order to ensure that outcomes differences be attributable to an intervention, the model building module uses propensity-score models using the top features with good separation and orthogonality. The model building module matches in the propensity-score space students in various discrete outcomes (i.e., continuing vs. non-continuing) to ensure that the matching is done in the good feature vector space. The matching in propensity score improves the probability that differences in outcomes can be attributed to the intervention under consideration.

In the 2D space, the model building module 116 usually works with, but not limited to, 4 quadrants, separated by the centroid in the 2D vector space. The same process is repeated for 3 features in the 3D vector space. In the 3D space, the model building module usually works with, but not limited to, 8 cubes.

Such visualizations and drill-down analyses provide further insights into why seemingly good/poor students on the surface perform in the opposite direction. These insights will help us tailor interventions down to a micro-segment level for effective personalization.

The automation analytics system 100 provides a fundamental suite of tools, visualizations, and models with which to perform additional drill-down analyses for extracting deeper insights and identifying intervention opportunities.

The automation analytics system 100 provides the following innovations:

(1) Automated, Data-Adaptive, Hierarchical Model Building

The automation analytics system 100 builds the predictive models in five stages. During the first stage, time-series and derived features are scanned to identify a manageable number of data-availability segments based with global feature optimization for weighting during segmentation. Next, during the second stage, the automation analytics system identifies key student-success drivers for each data-availability segment. During the third stage, the automation analytics system uses the optimized feature subset to find student clusters within each data-availability segment, where each cluster contains a relatively homogeneous subset of students for transparency. Next, during the fourth stage, the automation analytics system performs feature optimization and model training for each cluster-segment combination, thereby identifying key drivers for success in each segment-cluster for transparency, actionable insights, and model robustness. Finally, during the fifth stage, the automation analytics system performs sensitivity analysis at a student or student-enrollment level to surface key drivers for success at that level. That is, the automation analytics system computes relative contribution of each key driver to the student's success and rank order the segment-cluster level key drivers for that student based on the relative level of contribution of each key driver or feature.

(2) Marriage of Predictive Models and Propensity Score Models for Outcomes Analysis

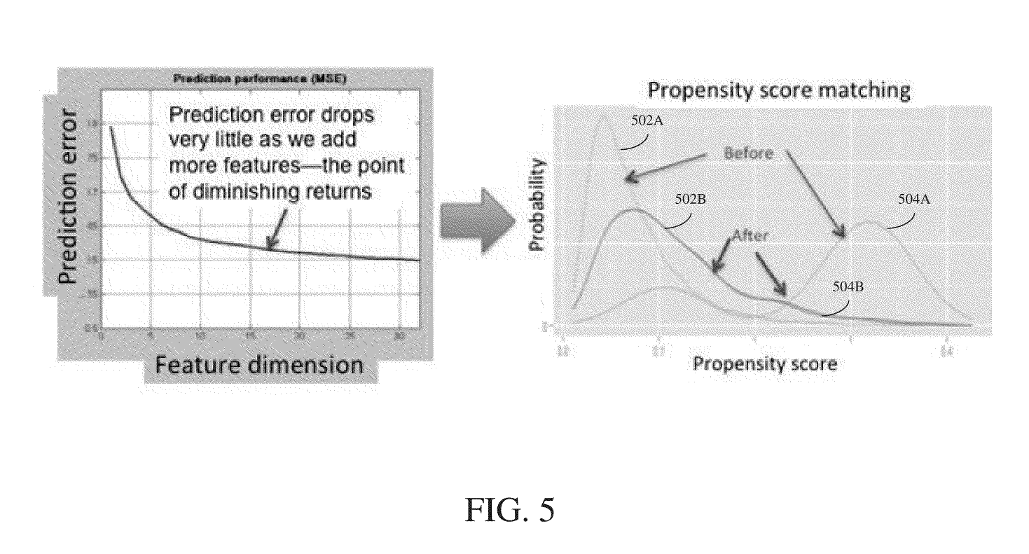

Most observational studies or small-sample randomized controlled trials (RCT) may suffer from selection bias, regression to the mean, and too many confounding variables without proper matching between test and control subjects in highly-predictive covariates or features. Most straight propensity-score matching methods (PSM) may be inadequate if matching variables have little-to-no predictive power. A paper by P. C. Austin titled “A critical appraisal of propensity-score matching in the medical literature between 1996 and 2003” reports that a majority of PSM-based clinical research papers failed to use appropriate statistical methods in balancing treated and untreated subjects. In order to address these issues simultaneously within the automation framework of the system, predictive models are combined with PSM so that an “on the fly” matching control group can be created that is indistinguishable from the intervention population, i.e., apple-to-apple comparison, in the highly predictive covariate vector space, which can encompass inclusion/exclusion criteria. The system accomplishes apple-to-apple comparison as follows:
a) Identify inclusion/exclusion criteria and key success drivers or student covariates/features from our predictive model building process.
b) Construct propensity-score models using the top features from step a) to enable matching in the highly predictive propensity-score domain. This ensures that the matching control population selected at the baseline of intervention is expected to perform similarly to the intervention population.
c) Perform various statistical hypothesis testing with Bonferroni correction as a function of time and various student segments to explain what interventions work for which segments of the student population under what context. FIG. 5 illustrates the approach of the automation analytics system 100 to outcomes analysis using, for example, scholarship programs. The automation analytics system first uses data-availability segmentation and use each segment's top features in matching. The automation analytics system uses rank-order curves (shown on the left in FIG. 5) to identify the point of diminishing returns. The automation analytics system shows propensity score distributions before and after matching for scholarship programs, where the system uses the award of various scholarship programs as pilot to assess the impact of scholarship programs on student success. The dotted lines 502A and 504A represent propensity-score distributions for the control and pilot, respectively, without proper matching. The solid lines 502B and 504B, which are nearly identical, correspond to the same propensity-score distributions after the matching process, thus ensuring that system is comparing apples with apples.

(3) Course-Success Prediction

The automation analytics system 100 uses multiple techniques—for example, course/student similarity analyses, collaborative filtering, clustering of students based on the most predictive feature subset for course success and identifying similar courses similar students have taken, and dynamic feature-based prediction—to predict initial course success for guidance during advising sessions. In addition, using dynamic features as a term progresses, the models continuously update course-success predictions as well as time-dependent key drivers for engaging students and driving interventions. Course-grade prediction using the automation analytics system in accordance with an embodiment of the invention is now described in detail.
a) Course similarity analysis: From millions of enrollment records, identify a subset of high-similarity courses, where students tend to perform similarly.
b) Clustering of students: Using top features in course-success prediction models for various data-availability (DA) segment-clusters, create data-adaptive clusters. Each student belongs to one of the data-adaptive clusters.
c) Single-student course based collaborative filtering (SSCCF): For a student about to take course X, identify the subset of high-similarity courses that contains X. If the student took courses in the subset, the course-grade prediction for X is the weighted average of the past similar-course grades, where weights are similarity coefficients.
d) Multi-student based collaborative filtering (MSCF): For a student with SSCCF failure (i.e., no similar courses taken in the past), the system identifies the cluster the student belongs to, perform k-nearest neighbor search, and identify similar courses the k-nearest students took in the past. The system uses the weighted average of the past similar-course grades that these students took.
e) Blended prediction: In certain situations, the system may blend the predictions of SSCCF and MSCF for better predictions.
f) Dynamic course-grade prediction: As a term progresses, the system gets more activity and inferred-behavior features. The system uses them to improve prediction accuracy by running models at regular intervals. The system can also blend traditional feature-based predictive algorithms with collaborative filtering ones in a factorization machine for improved accuracy and expressiveness. These course-grade predictions are also input to continuation and graduation models.

(4) Course Combination and Pathway Analysis

Using various representations of concurrent-course combinations and their grades along with key student attributes for success, the automation analytics system 100 looks for course-combination clusters that lead to unusual outcomes in comparison with when they were taken separately in different combinations. By using predicted course success as a proxy for student skills, the system can estimate inherent course difficulties adjusted for student skills to identify gatekeeper courses, and toxic or synergistic course combinations. These findings form the foundation of course-schedule optimization over time that can lead to student success and graduation. Optimizing course schedule using the system in accordance with an embodiment of the invention is now described in detail.
a) Course-combination clustering (CCC): Using 2-digit Classification of Instructional Programs (CIP) codes, course concept maps, and course levels, the system groups similar course combinations into a cluster. Each cluster becomes a node in a Viterbi traversing tree network.
b) Assignment of each student-term to one of the CCCs: Based on concurrent courses a student takes for a term, this student-term is assigned to an appropriate course-combination cluster.
c) Calculation of node fitness and transition probabilities: Each node has a fitness score as a composite of various student success measures. Associated with each node is a set of new clusters based on student attributes as part of predicting student success measures from student attributes. The system also computes probabilities of students in one node transitioning into different nodes in the next term.
d) Recommendation of optimal path: Given the current node a student belongs, the system can use the forward-backward inference algorithm to find the path with the highest predicted fitness score. The system can also embed constraints (required courses for majors) or recalculate path as part of a “what-if-I-change-major” game.

(5) Activity-Intervention-Performance Heat Maps

In health care, a patient's health heat map derived from various claims and clinical data has been used to provide not only the patient's risk scores, but also ongoing disease progression as a function of interventions and lifestyle parameters using a dynamic Bayesian network framework. Similarly, the automation analytics system 100 uses data from LMS, SIS, Customer Relationship Management (CRM), and other data sources to produce a student's heat map along his or her education journey in accordance with an embodiment of the invention as follows:
a) The system can overlay faculty-student interactions, student-student interactions, student performance, and predicted scores to get a complete understanding of how these variables interact with one another. For instance, an instructor's empathetic email peppered with tips on how to improve poorly-understood concepts right after an exam on which the student did not do so well may have a much greater impact than when sent at random time.
b) The system can also visualize and annotate such impacts by comparing and contrasting differences in student activities before and after the email. The activity changes before and after can be calculated and annotated on the heat map for clear dissemination of key insights.
c) The system can overlay interventions and student performances so that faculty, advisors, and students become smarter by learning associations and causal relationships between what they do and subsequent outcomes. Research shows such direct, real-time feedback through apps and visual annotations on a Web dashboard is highly effective in behavior change.

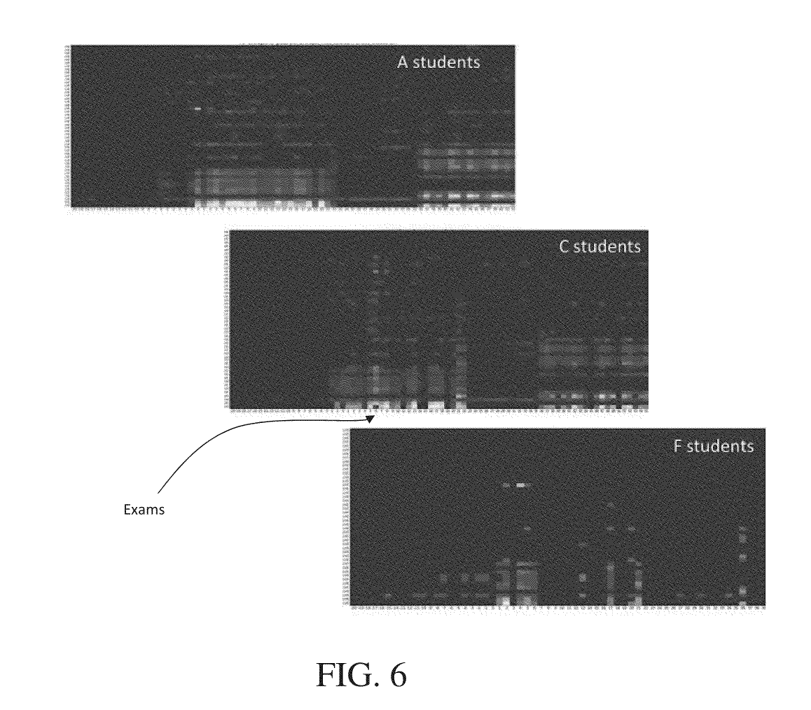

FIG. 6 shows examples of student activity heat maps over two terms for grades A, C, and F students. As illustrated in these student activity heat maps, there are distinct patterns of activities among A, C, and F students. It is interesting that A students are very consistent in daily activities and that there is no trace of cramming right before exams. On the contrary, there is procrastination followed by cramming for C students as denoted by higher-activity levels right before exams. The automation analytics system 100 extends this analysis to multiple terms so that the system can derive such behavior and behavior-change features not only within a term, but also from term to term.

(6) Inferring Non-Cognitive Factors from the AIP Map

Inferring non-cognitive factors from the AIP map using the automation analytics system 100 in accordance with an embodiment of the invention is now described in detail.
a) Define significant raw events at SIS and LMS levels. Examples include, but not limited to, finals, exams, project due dates, homework due dates, students being connected through discussion forums, spring breaks, Thanksgiving, college athletic events, etc.
b) Define intervention events based on various outreach programs. Examples include, but not limited to:
   i) Faculty reaching out to students proactively based on their risk scores
   ii) Faculty posting questions on discussion forums to see if students understand key concepts before an exam
   iii) Faculty posting homework or quiz to be turned in by a specific due date
   iv) Students visiting faculty during office hours to discuss course subjects
   v) Faculty responding to student questions posted on a discussion forum
   vi) Faculty posting video lecture prior to holding Q&A sessions in flipped courses
   vii) Students reaching out to faculty, which results in faculty responses and further dialogues
   viii) Faculty sending SMS messages to students giving them tips and making announcements with some of them requiring student responses
c) Measure activities before and after such events and compute meta-features to characterize the change in activities around these events at intra- and inter-event timeframe. Based on the directionality of connections, the system can determine influencers as well as those who can be influenced through such connections.
d) Assign to each event the nearest-future performance measure, such as exam grade and homework grade.
e) Develop cluster-driven predictive models to associate with success the meta-features on activity-change patterns. This step will create successful and unsuccessful clusters along with meta-features on student activities and inferred behaviors highly associated with success or failure.
f) Examples of SIS activities: Grades, credits attempted vs. earned, add/drop/withdrawal, transfer credits, grade distributions within a term and over multiple terms on various concept categories, change in affordability gap, change in credit load, sudden increase in add/drop/withdrawal.
g) Examples of derived events that provide insights into non-cognitive factors: Good student doing poorly on at least one course with activity-intensity discrepancies, bad student doing well on at least one course with too much activity on the course he or she is doing well, student bounce back after a poor grade with commensurate increase in activities (dealing with adversities), correlation between course-specific activity level and grade consistency (student proficiency or inherent difficulty in certain subjects), comparison in activities around social and academic events (social activities and life-work balance), etc.

(7) Faculty Engagement and Influence Scores

The system's construct for faculty engagement and influence scores is based on the following core tenets.
a) Faculty effectiveness should be demonstrably related to student success.
b) Faculty effectiveness measures must be transparent and personalized.
c) Faculty should not be penalized for working with difficult students, with not much to show for. However, the scores should provide guidance to the faculty on how to improve student success efficiently. That is, our measure should provide high-quality feedback on key aspects of a teacher's practice as part of faculty coaching.
d) Good faculty behaviors that lead to improved student success need to be measured and be part of coaching.

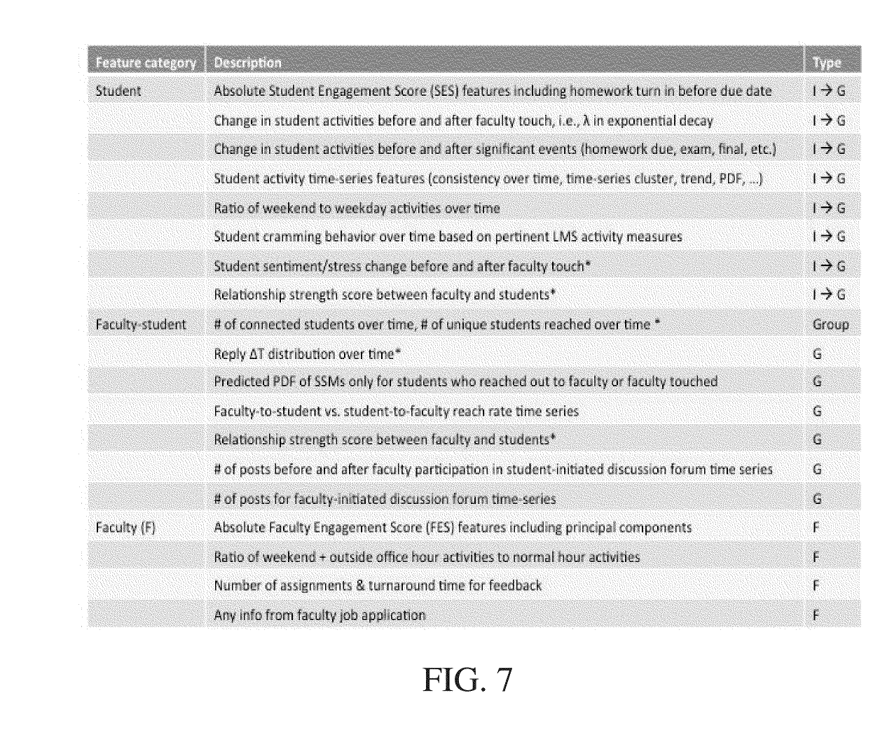

While traditional professional profiling algorithms focus on the cost of care adjusted for patient severity for physicians or on determining and then predicting the level of expertise, the approach used by the automation analytics system 100 looks for multiple outcomes variables, such as course success, withdrawal, continuation, improvements in these measures in comparison to predictions, and measurable changes in student behaviors/activities throughout the course and after student-faculty interactions. Based on these tenets, the system constructs the faculty engagement and influence scores as follows:
a) Predict three student success measures (SSM)—no withdrawal, course completion, and continuation—using features defined in the table shown in FIG. 7, which shows examples of features used in faculty engagement/influence score construction (The terms, G and I, refer to group and individual features, respectively. Individual student features can be rolled up to group-level features.) Compare student success predictions against actual success metrics measured in grades for sections an instructor is teaching and whether or not the student continued to the next term.
   i) Predictive ratio, defined as the sum of predicted to the sum of actual, should be 1, but it can be higher or lower depending on external factors including faculty influence.
   ii) Identify good faculty and faculty-student interaction features in predicting SSMs, residual between predicted and actual SSMs, and changes in desirable student behavior features from LMS.
b) Quantify change in student behavior post faculty engagement—focus on student behaviors highly associated with student success.
   i) Use propensity-score matching to measure the degree of change pre and post faculty intervention.
   ii) Faculty interventions that impact student behaviors associated with success should be weighted more heavily.
   iii) Rank order faculty interventions based on the magnitude of student behavior changes post interventions.
c) Repeat steps a)-b) for various clusters of students to see which faculty can influence which student clusters the most and to identify key drivers for each cluster.
d) Create a lookup table of effective faculty-student and faculty features as a function of student segments/clusters.
e) Faculty influence score is an output of a nonparametric algorithm that maps faculty-student and faculty features onto the level of improvement in student success.
f) Perform micro propensity score matching along these segment-specific key drivers to measure true outcomes of faculty interventions and influence on student segments.

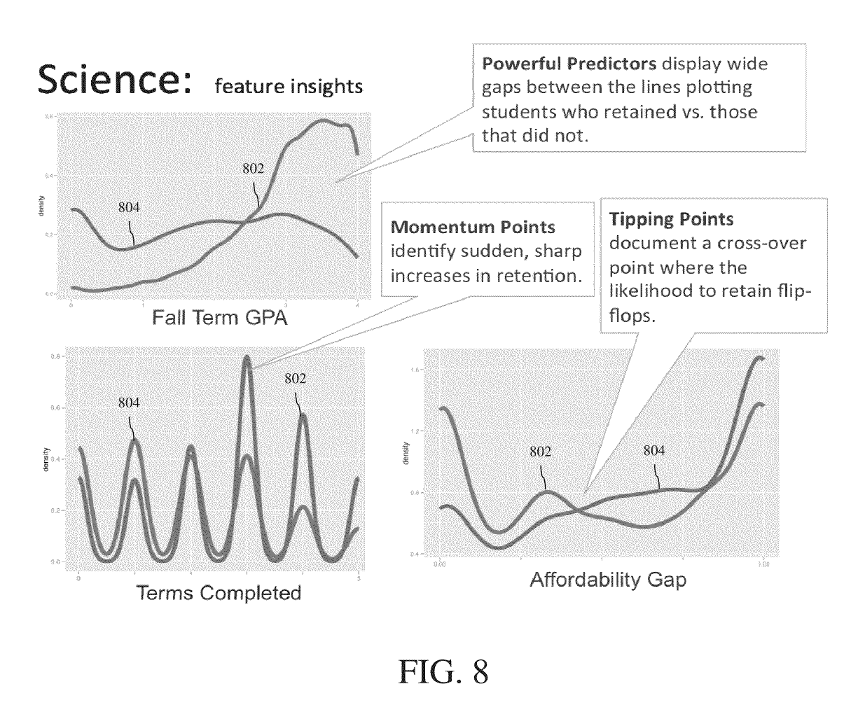

The following describes examples of insights that can be derived using the system. The first example is related to features that are good for prediction accuracy and/or insights. This example is described with reference to FIG. 8, which shows two class-conditional PDF plots for continuing (802) and non-continuing (804) students based on the number of cumulative GPA, terms completed, and affordability gap, which is the ratio of what the student owes to the university (tuition—financial aid) to the amount of tuition. As expected, the higher the GPA, the more likely the student is to persist. What is also surprising is that a fair number of high-GPA students do not persist, which can be answered through drill-down analysis. The terms completed feature shows that the more terms completed, the more likely the student is to persist. What's interesting is that there is a strong momentum point at 3 terms at an institutional level. In addition, it was discovered that the momentum point in terms completed varies from segment to segment with students in some segments requiring 5-7 terms. The affordability gap feature shows a tipping point of around 43%. This picture, coupled with other features can shed insights into how to optimize the allocation of financial aid dollars to maximize student success.

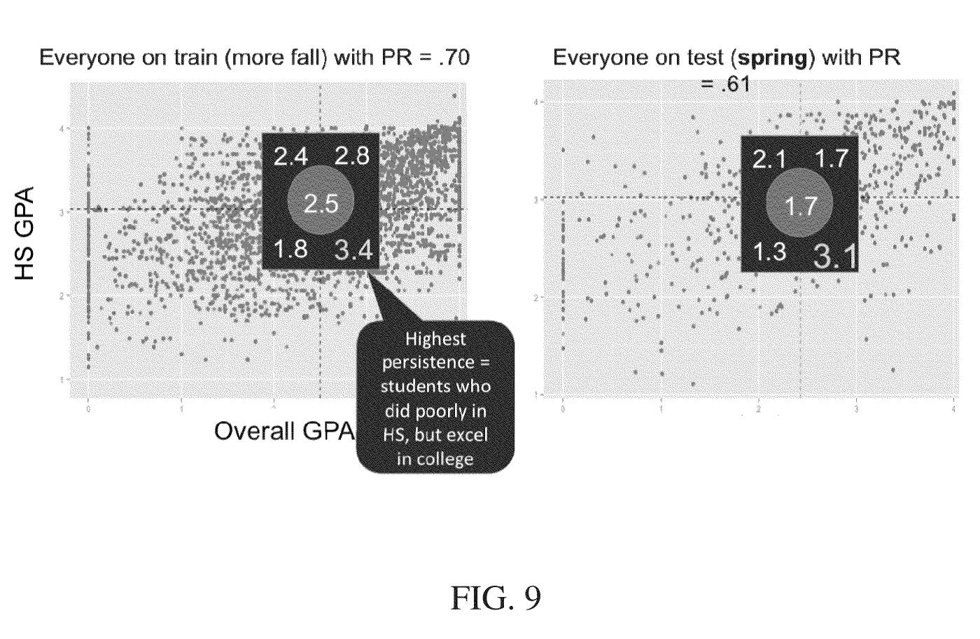

The second example of insights is 2×2 quadrant view with drill-down analysis. This example is described with reference to FIG. 9, which shows a 4-quadrant view of students who have high-school GPA and cumulative institutional GPA. The 2×2 scatter plot over high school GPA and community college GPA paints an interesting picture. The five numbers in the centroid (50%-50% line) represent the ratio of the number of students who persist to that of students who do not for all and each of the four quadrants. Persistence rate drops significantly in spring, in part due to high-performing students transferring out. Poor-performing high-school students who excel in community college, i.e., students in quadrant 4, tend to outperform students in Q1 in both fall and spring, in particular. Given the research findings in the paper titled “Should community college students earn an associate degree before transferring to a four-year institution?” by P. Crosta and E. Kopko, that show that students who earn their 2-year degrees in community college and then transfer to four-year institutions do much better in earning their Bachelor's degree, this observation points to an intervention research program to counsel students to earn their 2-year associate degrees and then transfer out.

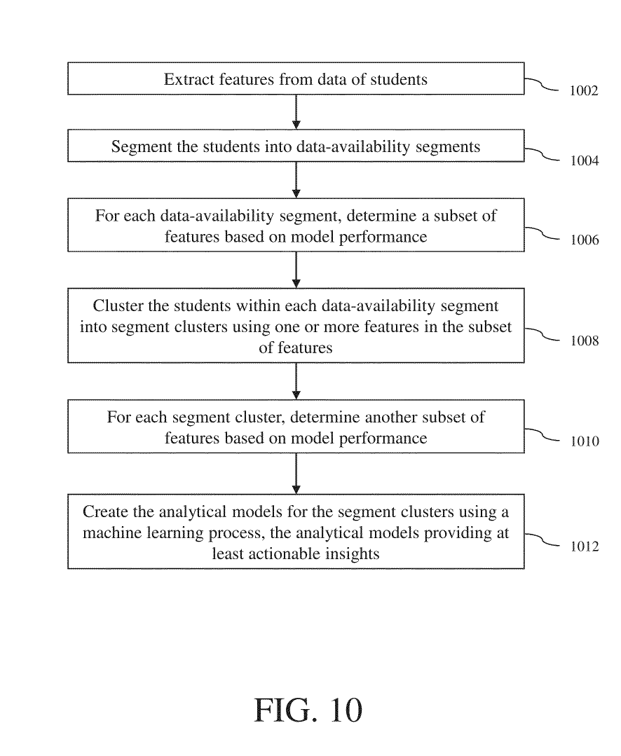

A method for building analytical models for an education application in accordance with an embodiment of the invention is now described with reference to the process flow diagram of FIG. 10. At block 1002, features from data of students are extracted. At block 1004, the students are segmented into data-availability segments. At block 1006, for each data-availability segment, a subset of features is determined based on model performance. At block 1008, the students within each data-availability segment are clustered into segment clusters using one or more features in the subset of features. At block 1010, for each segment cluster, another subset of features is determined based on model performance. At block 1012, the analytical models for the segment clusters are created using a machine learning process. The analytical models provide at least actionable insights.

In an embodiment, the methods or processes described herein are provided as a cloud-based service that can be accessed via Internet-enabled computing devices, which may include personal computers, laptops, tablet, smartphones or any device that can connect to the Internet.

It should be noted that at least some of the operations for the methods or processes described herein may be implemented using software instructions stored on a computer useable storage medium for execution by a computer using one or more processors. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

What is claimed is:

1. A method for building analytical models for an education application, the method comprising:
extracting features from data of students;
segmenting the students into data-availability segments;
for each data-availability segment, determining a subset of features based on model performance;
clustering the students within each data-availability segment into segment clusters using one or more features in the subset of features;
for each segment cluster, determining another subset of features based on model performance; and
creating the analytical models for the segment clusters using a machine learning process, the analytical models providing at least actionable insights.

2. The method of claim 1, wherein the creating the analytical models includes combining predictive models with propensity-score matching.

3. The method of claim 2, wherein the combining the predictive models with the propensity-score matching includes identifying key success features from a predictive model building process and constructing propensity-score models using one or more of the key success features to enable matching in highly predictive propensity-score domain.

4. The method of claim 1, further comprising performing statistical hypothesis testing with Bonferroni correction as a function of time and various segments to explain what interventions work for which segments of the students under what context.

5. The method of claim 1, further comprising predicting initial course success for guidance using at least one of course/student similarity analyses, collaborative filtering, clustering of the students based on a predictive feature subset for course success and identifying similar courses similar students have taken, and dynamic feature-based prediction.

6. The method of claim 1, further comprising estimating inherent course difficulties adjusted for student skills to identify gatekeeper courses, and toxic or synergistic course combinations using representations of concurrent-course combinations and their grades along with key student attributes for success.

7. The method of claim 1, further comprising producing a heat map of a particular student that includes faculty-student interactions, student-student interactions, student performance and predicted scores to provide an understanding of how these variables interact with one another.

8. The method of claim 1, further comprising producing a table of effective faculty-student and faculty features as a function of student segments/clusters using student success measures and changes in student behavior post faculty engagement.

9. A computer-readable storage medium containing program instructions for method for building analytical models for an education application, wherein execution of the program instructions by one or more processors of a computer system causes the one or more processors to perform steps comprising:
extracting features from data of students;
segmenting the students into data-availability segments;
for each data-availability segment, determining a subset of features based on model performance;
clustering the students within each data-availability segment into segment clusters using one or more features in the subset of features;
for each segment cluster, determining another subset of features based on model performance; and
creating the analytical models for the segment clusters using a machine learning process, the analytical models providing at least actionable insights.

10. The computer-readable storage medium of claim 9, wherein the creating the analytical models includes combining predictive models with propensity-score matching.

11. The computer-readable storage medium of claim 10, wherein the combining the predictive models with the propensity-score matching includes identifying key success features from a predictive model building process and constructing propensity-score models using one or more of the key success features to enable matching in highly predictive propensity-score domain.

12. The computer-readable storage medium of claim 9, wherein the steps further comprises performing statistical hypothesis testing with Bonferroni correction as a function of time and various segments to explain what interventions work for which segments of the students under what context.

13. The computer-readable storage medium of claim 9, wherein the steps further comprises predicting initial course success for guidance using at least one of course/student similarity analyses, collaborative filtering, clustering of the students based on a predictive feature subset for course success and identifying similar courses similar students have taken, and dynamic feature-based prediction.

14. The computer-readable storage medium of claim 9, wherein the steps further comprises estimating inherent course difficulties adjusted for student skills to identify gatekeeper courses, and toxic or synergistic course combinations using representations of concurrent-course combinations and their grades along with key student attributes for success.

15. The computer-readable storage medium of claim 9, wherein the steps further comprises producing a heat map of a particular student that includes faculty-student interactions, student-student interactions, student performance and predicted scores to provide an understanding of how these variables interact with one another.

16. The computer-readable storage medium of claim 9, wherein the steps further comprises producing a table of effective faculty-student and faculty features as a function of student segments/clusters using student success measures and changes in student behavior post faculty engagement.

17. An automation analytics system comprising:
a feature extraction module configured to extract features from data of students;
a segmentation module configured to segment the students into data-availability segments;
a segment feature optimizing module configured to determine a subset of features based on model performance for each data-availability segment;
a clustering module configured to cluster the students within each data-availability segment into segment clusters using one or more features in the subset of features;
a cluster feature optimizing module configured to determine another subset of features based on model performance for each segment cluster; and
a model building module configured to create analytical models for the segment clusters using a machine learning process, the analytical models providing at least actionable insights.

18. The automation analytics system of claim 17, wherein the model building module is configured to combine predictive models with propensity-score matching to create the analytical models.

19. The automation analytics system of claim 18, wherein the model building module is configured to identify key success features from a predictive model building process and to construct propensity-score models using one or more of the key success features to enable matching in highly predictive propensity-score domain.

20. The automation analytics system of claim 17, wherein the model building module is configured to perform statistical hypothesis testing with Bonferroni correction as a function of time and various segments to explain what interventions work for which segments of the students under what context.

21. The automation analytics system of claim 17, wherein the model building module is configured to predict initial course success for guidance using at least one of course/student similarity analyses, collaborative filtering, clustering of the students based on a predictive feature subset for course success and identifying similar courses similar students have taken, and dynamic feature-based prediction.

22. The automation analytics system of claim 17, wherein the model building module is configured to estimate inherent course difficulties adjusted for student skills to identify gatekeeper courses, and toxic or synergistic course combinations using representations of concurrent-course combinations and their grades along with key student attributes for success.
